(19) United States
(12) Patent Application Publication
(10) Pub. No.: US 2003/0091705 A1
(43) Pub. Date: May 15, 2003

(54) Process for the preservation of fresh quality attributes of peeled, whole and peeled, cut kiwifruit

(76) Inventors: Perry Lidster, Yarrow (CA); Miriam O'Donovan, North Vancouver (CA); Cheong Kit Leung, Vancouver (CA); William D. Powrie, North Vancouver (CA)

Correspondence Address: Oyen Wiggs Green & Mutala, #480 - The Station, 601 West Cordova Street, Vancouver, BC, V6B 1G1, CA

(21) Appl. No.: 09/986,505

(22) Filed: Nov. 9, 2001

(51) Int. Cl. A23C 1/00

(52) U.S. Cl. 426/316

(57) ABSTRACT

This invention relates to a novel process for preserving the quality of peeled ripe kiwifruit. More particularly, the invention pertains to a process for preserving the firmness, tissue integrity, bright green color and natural fresh, ripe kiwifruit flavor of peeled, whole, ripe kiwifruit and of peeled, cut, ripe kiwifruit pieces at refrigerated temperatures for prolonged storage periods. A process for preserving ripe kiwifruit or ripe kiwifruit pieces comprising: (a) treating whole, unpeeled, fresh, ripe, kiwifruit with nitrogen to inhibit quality deterioration of pericarp tissue of the ripe kiwifruit; (b) peeling the whole, unpeeled, fresh, ripe kiwifruit; and (c) packaging the peeled, whole kiwifruit or peeled kiwifruit cut into pieces in a modified atmosphere package containing an initial modified atmosphere of between 5% and 15% of oxygen and between 2 and 10% carbon dioxide.

### FIELD OF THE INVENTION

This invention relates to a novel process for preserving the quality of peeled ripe kiwifruit. More particularly, the invention pertains to a process for preserving the firmness, tissue integrity, bright green color and natural fresh, ripe kiwifruit flavor of peeled, whole, ripe kiwifruit and of peeled, cut, ripe kiwifruit pieces at refrigerated temperatures for prolonged storage periods.

### BACKGROUND OF THE INVENTION

Fresh, ripe fruits with pleasant aroma, flavor, color and texture are enjoyed by consumers. Whole fresh fruits are frequently peeled, cored, de-seeded and segmented in the home and in food service establishments prior to consumption. Packaged, pre-cut, ready-to-eat, fresh fruits are appealing to consumers and to the food service industry because of the convenience, apparent freshness and storability.

Packaged, peeled, whole, ripe kiwifruit and peeled, cut, ripe kiwifruit pieces could be year-round fruit commodities since kiwifruit can be stored for many months under controlled atmosphere and can be sourced from tropical and semi-tropical countries north and south of the equator. For successful marketing of the packaged, peeled, fresh kiwifruit products, the excellent ripe fruit attributes must be retained during storage of the packaged products at refrigerated temperatures for periods up to 20 days.

Kiwifruit is a berry (a Chinese gooseberry) with a thin layer of epidermal cells on the surface, above the edible, green-colored outer and inner pericarp and the white core. Generally, the hairy, leathery epidermal layer of the fruit is removed by peeling prior to consumption. However, the epidermal layer of the kiwifruit is only a few cells deep, and a cutting tool such as a knife must impinge on the outer pericarp of the fruit to form a cohesive peel. This results in the loss of valuable fruit due to peeling. The loss in weight may range from 5 to 25% depending on the type and sharpness of the cutting tool, as well as the depth of the shearing blade in the outer pericarp. The shearing action of a cutting blade in the outer pericarp causes the breakage of the walls of intact parenchyma cells where-upon cell contents become disorganized and enzymes become decompartmentalized. Cutting kiwifruit into pieces brings about damage to intact cells in the outer and inner pericarp, and also the core. As a consequence of shearing damage to kiwifruit cells, the respiration rate and ethylene production are increased (Watada et al., Food Technology, May, pages 116-122, 1990; Agar et al., J. Food Sci. vol.64, pages 433-440, 1999).

The major quality loss of stored, peeled, fresh, ripe kiwifruit products is the loss of firm texture. The texture of kiwifruit is a perceptual manifestation of the physical state of the tissue. In particular, the physical characteristics of cell walls, cell turgidity, vacuolar size and fluidity, proportion of fundamental and vascular tissues, and tenacity of the middle lamellae between cells are all contributors to the texture of kiwifruit. Changes in the texture of kiwifruit during storage and after cutting can be attributed mainly to chemical changes in the cell wall and middle lamella components, particularly pectic substances. The high concentrations of pectic substances in the cell walls contribute to the mechanical strength of the cell wall. The cell to cell adhesion in kiwifruit tissue has been attributed to the pectic substances in the middle lamella. Enzymic breakdown of the pectic substances in the kiwifruit cell walls by pectinases to more water soluble compounds is undoubtedly a major factor in the decrease in the firmness of the edible flesh.

Varoquaux et al. (Science des Aliments 10, 127-139, 1990) and Agar et al. (J. Food Science, 64, 433-440, 1999) reported that peeled, sliced kiwifruit lost about one-half of the firmness within 2 to 3 days of storage at about 2 to 5° C. At higher storage temperatures, the rate of tissue softening of the stored peeled, sliced kiwifruit increased. According to O'Connor-Shaw et al. (J. Food Science 59, 1202-1205, 1994), the shelf life of sliced kiwifruit pieces was found to be 2 days when the storage temperature was 4° C. These researchers noted that the firm texture of freshly-prepared kiwifruit pieces decreased markedly during storage at 4° C. over a 4 day period. Also, bitterness of the fruit increased.

Other quality defects which arise during the storage of peeled, cut, ripe kiwifruit include water-logging of the outer pericarp as evidenced by the appearance of tissue translucency, and sloughing of tissue at the edges of the kiwifruit pieces. Such defects may be attributed to the breakdown of the pectic substances in the cell walls and middle lamellae. Water-logging of the kiwifruit pericarp could be due to the disruption of the very thin walls of the parenchyma cells and the release (leakages) of the watery cell fluids. The loss of cellular adhesion through protopectin breakdown in the middle lamellae may be the cause of sloughing at the cut edges of the kiwifruit pieces. Bruising of the tissue during peeling can accelerate the evolution of sloughing.

Alteration of the gas composition of the microatmosphere around a fruit can be effective for prolonging the storage life of the fruit. Modified atmosphere packaging (MAP) is a process which is based on the fact that low concentrations of O₂ and moderate to high concentrations of CO₂ in the microatmosphere around fruit can bring about beneficial chemical changes in fruit tissue for the extension of shelf-life with the retention of quality attributes (Powrie and Skura, “Modified Atmosphere Packaging of Fruits and Vegetables”, Ellis Horwood, 1991, pages 169-245).

Prior to the peeling and cutting of ripe kiwifruit, mature but unripe kiwifruit with soluble solids content of about 6% and firmness values of about 60N may be stored successfully for up to 6 months under controlled atmosphere (CA) conditions. The recommended atmosphere for CA storage of unripe kiwifruit of 0° C. is 5% CO₂ and 2% O₂. At the end of 6 months of CA storage, the unripe kiwifruit retains a bright green color, a white core and a firm texture.

### SUMMARY OF THE INVENTION

This invention relates to novel process steps for the preservation of the firmness, tissue integrity, bright green color and natural fresh, ripe kiwifruit flavor of peeled, whole and of peeled, cut kiwifruit pieces held at refrigerated temperatures for extended storage periods up to 20 days.

The objectives of the invention, which are achieved from the implementation of the impact process steps presented in this invention for the preservation of fresh quality attributes of peeled, whole, ripe kiwifruit and peeled, cut, ripe kiwifruit stored for prolonged periods, are:

1. retardation of the softening of the pericarp tissue;

2. inhibition of the development of water-logged pericarp tissue;

3. prevention of the development of sloughing on the cut edges of kiwifruit pieces;

4. retention of the typical fresh, ripe kiwifruit flavor;

5. retention of the bright green color;

6. inhibition of off-flavor development;

7. reduction in respiration rate;

The invention consists of novel process steps including:

1. cooling the whole, ripe kiwifruit to a temperature of between 0 and 6° C.;

2. subjecting the whole, ripe kiwifruit to an atmosphere containing 98 to about 100% nitrogen (or some other suitable inert gas such as argon) within a closed container;

3. peeling the pretreated kiwifruit with sharp blades either manually or by a peeling machine;

4. if necessary, cutting the peeled kiwifruit into appropriate pieces;

5. introducing a specific gas mixture into the headspace of punnet packages containing whole kiwifruit or kiwifruit pieces and sealing each package with a top web plastic film or into the headspace of flexible plastic bags with peeled kiwifruit products having specific gas barrier properties;

6. quick-chilling of kiwifruit pieces in the sealed packages to 0 to 6° C.

The nitrogen gas pretreatment of whole kiwifruit may be carried out with:

1. a continuous flow of nitrogen gas into the headspace of a closed container for periods of 1 to 5 days at 0 to 6° C.; or

2. a nitrogen gas flush of a large headspace of a closed high gas barrier container to be held with a static gas headspace at 0 to 6° C. for 1 to 5 days.

The packages for holding the peeled kiwifruit pieces should have semi-rigid walls with high gas barrier properties. The top web plastic film should have an oxygen gas transmission value of between 3000 and 4500 cu.cm per in² per 24 hours @ 25° C. at 1 atm. The gas mixture flush introduced into the headspace of the kiwifruit-containing packages should have an O₂ content of between 5 and 15% (preferably 8 to 12%) and between 2 to 10% CO₂ (preferably 3 to 5%). The packaged kiwifruit pieces are to be stored at temperatures between 0 and 6° C.

The invention is directed to a process of preserving ripe kiwifruit comprising: (a) selecting ripe kiwifruit with a pH of 3.2 to 4.0, soluble solids of 12 to 17%, and bright green color, white core, opaque pericarp and typical fresh, ripe kiwifruit flavor; (b) cooling the selected whole, fresh, unpeeled, ripe kiwifruit to a temperature between 0 and 6° C. in a refrigerated room; (c) treating the cooled whole, fresh, unpeeled, ripe kiwifruit with a nitrogen gas until the headspace in the room has an oxygen content of 2% or less (preferably 1% or less); (d) after nitrogen gas pretreatment, peeling and cutting the kiwifruit in a manner which avoids significant bruising to the outer pericarp of the ripe kiwifruit; and (e) placing the treated whole or peeled kiwifruit into sealed plastic packages (MAP punnets or bags) which have suitable gas transmission rates that ensure the attainment of high CO₂ levels (13 to 20%) and low O₂ levels (0.5 to 3%) in the headspaces after 20 days of storage at 1 t 6° C. (preferably 1 to 3° C.).

The ripe whole or peeled kiwifruit can be contained in closed containers and the nitrogen gas can be introduced into the kiwifruit-containing closed container as a continuous gas flow or as a gas flush, and after nitrogen gas pretreatment, the kiwifruit can be peeled manually or mechanically by sharp blades, and the packages can be semi-rigid, plastic punnets which can be flushed with the desired gas mixture and sealed with a specific low gas barrier top web plastic film or plastic bags composed of specific low-gas barrier plastic film.

The semi-rigid punnet can be constructed of a high gas barrier plastic and the top web plastic film can have an oxygen gas transmission rate between 3000 and 4500 cm₃ per m₂ per 24 hrs. @ 25° C. at 1 atm.

The sealed package of kiwifruit can contain a ratio of kiwifruit mass (grams) to total package volume (cm³) of between about 0.3 to 0.5. The headspace gas composition of the sealed package of kiwifruit after 20 days of storage at 0 to 6° C. can be between about 13 to 20% carbon dioxide and about 0.5 to 3.0% oxygen.

### DETAILED DESCRIPTION OF PREFERRED EMBODIMENTS OF THE INVENTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification is to be regarded in an illustrative, rather than a restrictive, sense.

This invention is a novel process involving nitrogen gas pretreatment of whole, fresh, unpeeled, ripe kiwifruit followed by modified atmosphere packaging of the nitrogen gas pretreated, peeled kiwifruit. The applicants have discovered unexpectedly that when oxygen is restricted from entry into kiwifruit, desirable chemical changes occur in the cells, the cell walls and the middle lamellae. During the nitrogen gas pretreatment, oxygen is restricted from entry into the whole, fresh, ripe kiwifruit and in situ anaerobic respiration occurs in the cells to create chemical changes. As a consequence, tissue disruption and softening of the pericarp tissue are inhibited, particularly when the pretreated, peeled kiwifruit pieces are subjected thereafter to modified atmosphere packaging (MAP). With MAP, the oxygen in the input gas flush is gradually converted to CO₂ which impedes the respiration rate and ethylene production of the fruit, both of which are involved in the quality deterioration of fruit products over time.

According to the invention, whole, unpeeled, ripe kiwifruit is to be pretreated with nitrogen gas for a period of several days to bring about beneficial chemical and microstructural changes in the ripe kiwifruit fruit prior to the stress-wounding of the tissue by peeling and cutting. These beneficial changes lead to the retardation of tissue softening, cellular disruption and cell wall fissuring of the peeled and cut kiwifruit. Modified atmosphere packaging is included as a subsequent process step for additively prolonging the shelf-life of the peeled ripe kiwifruit pieces.

In specific parameters, the process according to the invention for the preservation of fresh quality attributes of peeled, whole and peeled, cut kiwifruit involves the following:

1. Ripe kiwifruit are to be selected with the following criteria: weight of 95 to 115 grams per kiwifruit: penetrometer reading of 0.5 to 2 kgf (4.9 to 19.6N) preferably 1 to 2 kgf (9.8 to 19.6N) with a 8 mm plunger; pH 3.2 to 4.0, preferably 3.2 to 3.4; soluble solids of 12 to 17%, preferably 13-15%; bright green color; white core; opaque pericarp; typical fresh, ripe kiwifruit flavor.

2. The selected whole, fresh, unpeeled kiwifruit are cooled to temperatures between 0 and 6° C. With these low temperatures, the CO₂ produced in situ in the cells of the kiwifruit, through anaerobic metabolism is effectively dissolved in the cellular cytosol. Dissolved CO₂ can act as an inhibitor of quality deteriorating enzymes, and can enhance desirable chemical changes.

3. Nitrogen gas pretreatment of the cooled whole, fresh, unpeeled, ripe kiwifruit occurs within a container held in a refrigerated room at 0 to 6° C. The whole unpeeled kiwifruit can be contained in closed containers and the nitrogen gas can be introduced into the kiwifruit-containing closed container as a continuous gas flow or only as a gas flush. In both cases, the containers of kiwifruit are flushed with nitrogen gas until the oxygen content in the headspace is 2% or less (preferably 1% or less).

4. After nitrogen gas pretreatment, the kiwifruit can be peeled manually or mechanically by sharp blades. It is important that significant bruising to the outer pericarp is prevented. The kiwifruit may be cut into pieces of any size or shape.

5. The treated kiwifruit pieces should be held in or placed in sealed plastic packages (MAP packages) with suitable gas transmission rates which will ensure the attainment of high CO₂ levels (13 to 20%) and low O₂ levels (0.5 to 3%) in the headspaces after 20 days of storage at 0 to 6° C. (preferably 1 to 3° C.). Preferably, the packages should be semi-rigid, plastic punnets, which can be easily flushed with a desired gas mixture and readily sealed with a specific low gas barrier top web plastic film. The semi-rigid package should be a high gas barrier plastic and the top web plastic film should have oxygen gas transmission rates between 3000 and 4500 cm³ per m² per 24 hours @ 25° C. at 1 atm. Semi-rigid plastic punnets are preferable so that the delicate tissue of the kiwifruit is not damaged due to piece-to-piece squashing. Plastic bags can be used as packages if product squashing is obviated. For each sealed package of kiwifruit, the ratio of kiwifruit mass (grams) to the total package volume (cm³ ) is to be about 0.3 to 0.5.

6. The input gas mixture as a flush into each MAP package is to be about 5 to 15% O₂ (preferably 8 to 12%) and between 2 and 10% CO₂ (preferably 3 to 5%). To preserve the fresh quality attributes of the kiwifruit pieces, the headspace gas composition after 20 days of storage at 0 to 6° C. should be about 13 to 20% CO₂ and 0.5 to 3% O₂. The nitrogen gas pretreatment can be conducted on either a continuous or a static basis.

For continuous nitrogen gas flow pretreatment, whole, unpeeled, ripe kiwifruit at 0 to 6° C. (preferably 1 to 3° C.) is held in closed containers (with moderate to high gas barrier properties) having gas inlets in the bottom and gas outlets in the tops of the containers, To expedite the oxygen (in the air) evacuation from each container, a vacuum can be drawn and then nitrogen in introduced as the input gas. This can be repeated several times to bring about an initial 98 to about 100% (preferably 99 to about 100%) nitrogen gas concentration in the headspace. The continuous nitrogen gas flow into each container is regulated to ensure the maintenance of the high nitrogen gas concentration of 98 to 100% in the headspace during storage at 0 to 6° C. (preferably 1 to 3° C.). We have discovered that the storage time for the beneficial pretreatment of kiwifruit should be between 1 and 5 days (preferably 2 to 5 days at 1 to 3° C.).

For static nitrogen gas pretreatment, whole, unpeeled, ripe kiwifruit is held in closed containers with high gas barrier walls to impede the diffusion of outside air into the containers. Gas inlets are located at the bottom of the containers and gas outlets are located at the top. To expedite the oxygen (in the air) evacuation from each container, a vacuum as an option can be drawn, with nitrogen as the input gas. This can be repeated several times to bring about the initial 98 to about 100% concentration of nitrogen gas in the headspace. This type of pretreatment is to be carried out at 0 to 6° C. (preferably 1 to 3° C.) for 1 to 5 days (preferably 2 to 5 days).

### EXAMPLE b 1

Mature, ripe, unpeeled, whole kiwifruit were selected on the basis of acceptable quality attributes of the edible flesh, including the outer and inner pericarp and core. The quality requisites of the edible flesh were:

1. brilliant green color of the pericarp;

2. white core;

3. pH range of 3.2 to 3.6 for the pericarp;

4. penetrometer readings from 0.5 to 2 kgf (4.9 to 19.6 Newtons) for the pericarp with a plunger having a diameter of 8 mm;

5. percent soluble solids range of 13 to 16 for the pericarp;

6. fresh, ripe kiwifruit flavor.

The weights of the whole kiwifruit were within the range of 95 to 120 grams.

For the nitrogen gas pretreatment, whole, unpeeled, ripe kiwifruit at 1° C. were held in a closed container having a gas inlet and a gas outlet. The closed container was present in cold room at 1° C. The container was flushed with high velocity nitrogen gas to remove the oxygen. The 98 to about 100% nitrogen gas atmosphere in the headspace was maintained by the introduction of low velocity nitrogen gas for a period of about 48 hours.

After this nitrogen gas pretreatment period, the kiwifruit were peeled manually with sharp knives without causing significant bruising to the outer pericarp. Each peeled kiwifruit was cut transversely into two halves.

Four halves were placed in each semi-rigid PET package. After the packages were gas flushed with 10% O₂ and 4% CO₂, they were sealed with a plastic film having an oxygen transmission value of about 4000 cm³/m²/24 hours, at 25° C. at one atmosphere. For each sealed package of kiwifruit, the ratio of kiwifruit mass (grams) to total volume of the package (cm³) was about 0.4, The sealed package of kiwifruit were stored at 1° C. for 2 days and 4 to 6° C. for the remainder of the storage time-up to 20 days.

With respect to the control samples (kiwifruit halves stored in air-vented clamshell containers) with no nitrogen gas pretreatment, the fruit was rated by sensory panel members as not acceptable after 7 days of storage because of the following quality defects: water-logged, translucent pericarp appearance; sloughing of flesh along the edges; yellow-coloration of pericarp; very soft texture of pericarp.

When kiwifruit halves without nitrogen gas pretreatment were packaged under modified atmosphere conditions (10% O₂ and 4% CO₂), the product was rated by sensory panel members as unacceptable after 11 days of storage because of the following quality defects: water-logged, translucent appearance: dull gray core: slight sloughing of flesh along edges. The texture of the pericarp was soft and barely acceptable (rated 3 out of 5) and the flavor of the pericarp was found to be stale and anaerobic (rated 3 out of 5). Note: 3 rating is minimally acceptable.

When kiwifruit were subjected to nitrogen gas pretreatment and modified atmosphere packaging, the stored peeled fruit pieces were rated by sensory panel members as very acceptable even at day 20. As shown in Table 1, the fresh, unstored kiwifruit was rated 4.5 out of 5. After 7 and 14 days of storage, the sensory ratings were 4.2 and 3.8 out of 5, respectively. When the storage time reached 20 days. the kiwifruit ratings was 3.5 out of 5. It should be noted that a rating of 3 is the minimum value for acceptability of the fruit.

TABLE 1
Sensory Evaluation of Stored, Peeled Kiwifruit Pieces Subjected
to Nitrogen Gas Pretreatment and MAP

| Storage Time | Overall Acceptability |
|---|---|
| (Days) | (0-5) |
| 0 | 4.5 |
| 7 | 4.2 |
| 14 | 3.8 |
| 20 | 3.5 |

Note:
5 - highly acceptable
4 - moderately acceptable
3 - minimally acceptable
2 - unacceptable
1 - highly unacceptable

The quality attributes of peeled kiwifruit pieces held for 7, 14 and 20 days are presented in Table 2.

TABLE 2
Quality Attributes of Stored, Peeled Kiwifruit Pieces Subjected
to Nitrogen Gas Pretreatment and MAP

| Storage | | | |
|---|---|---|---|
| Time | | Quality Attributes | |
| (Days) | Appearance | Texture | Flavor |
| 0 | bright green | firm | typical kiwifruit flavor |
| | opaque | no sloughing | fruity odour |
| 7 | bright green | firm | typical kiwifruit flavor |
| | opaque | no sloughing | fruity odour |
| | white core | | |
| 14 | bright green | slightly soft | typical kiwifruit flavor |
| | opaque | no sloughing | fruity odour |
| | white core | | |
| 20 | slightly | slightly soft | typical kiwifruit flavor |
| | dark green | | |
| | slightly | no sloughing | fruity odour |
| | translucent | | |
| | white core | slight aldehyde odour | |

In particular, the firmness of the kiwifruit pericarp (green portion) decreased slightly over the 20 day storage period, and was rated as moderately acceptable at day 20. The pericarp remained opaque (no water-logging) up to at least day 14 and at day 20, the translucency of the tissue was slight (very little water-logging). No sloughing of the tissue at the edges of the pericarp was evident in samples stored for 20 days and the core of the fruit remained white throughout the storage period. The desirable typical kiwifruit flavor and fruity odour was apparent with kiwifruit storedup to 20 days. A slight aldehyde (ester) odour was detected with kiwifruit stored for 20 days.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A process for preserving the quality of peeled ripe kiwifruit or peeled ripe kiwifruit pieces during storage comprising:
(a) treating whole, unpeeled, fresh, ripe, kiwifruit with nitrogen or inert gas to inhibit quality deterioration of pericarp tissue of the ripe kiwifruit;
(b) peeling the whole, unpeeled, fresh, ripe kiwifruit; and if necessary cutting it;
(c) packaging the peeled, whole kiwifruit or peeled kiwifruit cut into pieces in a modified atmosphere package containing a modified atmosphere of between 5% and 15% of oxygen and between 2 and 10% carbon dioxide.

2. A process as claimed in claim 1 wherein the ripe unpeeled kiwifruit is treated with nitrogen gas for a period between 1 and 5 days.

3. A process as claimed in claim 1 wherein the ripe unpeeled kiwifruit is treated at a temperature between 0 and 6° C.

4. A process as claimed in claim 1 wherein the headspace above the unpeeled kiwifruit consists of nitrogen of 98 to about 100% purity.

5. A process as claimed in claim 1 wherein the initial modified atmosphere is between 8 and 12% oxygen and between 3 and 5% carbon dioxide.

6. A process for preserving ripe kiwifruit comprising:
(a) cooling whole, ripe kiwifruit to a temperature of between 0 and 6° C.;
(b) treating the whole, ripe kiwifruit in a closed container with a gas atmosphere containing 98 to about 100% nitrogen;
(c) peeling the nitrogen treated ripe kiwifruit with sharp blades;
(d) placing the peeled ripe whole kiwifruit or cut kiwifruit pieces in a package and introducing a modified atmosphere gas mixture into the headspace of the package containing the peeled whole kiwifruit or peeled kiwifruit cut into pieces;
(e) quick-chilling and storing the packaged ripe kiwifruit at a temperature between 0 and 6°.

7. A process as claimed in claim 6 wherein the nitrogen gas treatment of whole kiwifruit is conducted with:
(a) a continuous flow of nitrogen gas into the headspace of the closed container for a period of 1 to 5 days at 0 to 6° C.; or
(b) a nitrogen gas flush of the headspace of the closed container to provide a static nitrogen gas headspace at 1 to 6° C. for 1 to 5 days.

8. A process as claimed in claim 6 wherein the package for holding the peeled ripe kiwifruit or kiwifruit pieces has semi-rigid walls with high gas barrier properties.

9. A process as claimed in claim 8 wherein the package has a top web plastic film with an oxygen gas transmission value of between 3000 and 4500 cu. cm per sq. in. per 24 hours @ 25° C. at 1 atm.

10. A process as claimed in claim 9 wherein the gas mixture flush introduced into the headspace of the ripe kiwifruit-containing package has an O₂ content of between 5 and 15% and a CO₂ content of between 2 to 10%.

11. A process as claimed in claim 10 wherein the gas mixture has an O₂ content of between 8 to 12% and a CO₂ content of between 3 to 5%.

12. A process of preserving the quality of ripe peeled whole or cut kiwifruit pieces comprising:
(a) selecting ripe kiwifruit with a pH of 3.2 to 4.0, soluble solids of 12 to 17%, and bright green color, white core, opaque pericarp and typical fresh, ripe kiwifruit flavor;
(b) cooling the selected whole, fresh, unpeeled, ripe kiwifruit to a temperature between 1 and 6° C. in a refrigerated room;
(c) treating the cooled whole, fresh, unpeeled, ripe kiwifruit with a nitrogen gas until the headspace in the room has an oxygen content of 1% or less;
(d) after nitrogen gas pretreatment, peeling the kiwifruit in a manner which avoids significant bruising to the outer pericarp of the ripe kiwifruit; and
(e) placing the treated kiwifruit in sealed plastic packages (MAP packages) which have suitable gas transmission rates that ensure the attainment of high CO₂ levels (13 to 20%) and low O₂ levels (0.5 to 3%) in the headspaces after 20 days of storage at 0 to 6° C. (preferably 1 to 3° C.).

13. A process as claimed in claim 12 wherein the ripe kiwifruit is contained in closed containers and the nitrogen gas is introduced into the kiwifruit-containing closed container as a continuous gas flow or as a gas flush, and after nitrogen gas pretreatment, the kiwifruit is peeled manually or mechanically by sharp blades, and if necessary the kiwifruit is cut into pieces, and the packages are semi-rigid, plastic punnets which can be flushed with the desired gas mixture and sealed with a specific low gas barrier top web plastic film.

14. A process as claimed in claim 13 wherein the semi-rigid package is constructed of a high gas barrier plastic and the top web plastic film has an oxygen gas transmission rate between 3000 and 4500 cm₃ per m₂ per 24 hrs. @ 25° C. at 1 atm.

15. A process as claimed in claim 13 wherein the sealed package of kiwifruit contains a ratio of kiwifruit gram mass to total package cubic centimeter volume of between about 0.3 to 0.5.

16. A process as claimed in claim 13 wherein the headspace gas composition of the sealed package of kiwifruit after 20 days of storage at 0 to 6° C. is between about 13 to 20% carbon dioxide and about 0.5 to 3.0% oxygen.
